(19) United States
(12) Patent Application Publication
(10) Pub. No.: US 2021/0327086 A1
(43) Pub. Date: Oct. 21, 2021

(54) DETECTION METHOD FOR PEDESTRIAN EVENTS, ELECTRONIC DEVICE, AND STORAGE MEDIUM

(71) Applicant: SHENZHEN SENSETIME TECHNOLOGY CO., LTD., Shenzhen (CN)

(72) Inventors: Bo XU, Shenzhen (CN); Yanzhe XIN, Shenzhen (CN)

(21) Appl. No.: 17/361,841

(22) Filed: Jun. 29, 2021

Related U.S. Application Data
(63) Continuation of application No. PCT/CN2020/089071, filed on May 7, 2020.

(30) Foreign Application Priority Data
Nov. 28, 2019 (CN) 201911192848.8

(51) Int. Cl. G06T 7/70; G06T 7/20

(52) U.S. Cl. CPC G06T 7/70; G06T 7/20; G06T 2207/10016; G06T 2207/30196; G06T 2207/20084

(57) ABSTRACT

The present disclosure relates to a pedestrian event detection method and device, an electronic apparatus, and a storage medium. The method comprises: acquiring coordinates of a target pedestrian in multi-frame to-be-processed images; acquiring coordinates of a preset space; and determining a pedestrian events occurring to the target pedestrian in the preset space according to the coordinates of the target pedestrian in the multi-frame to-be-processed images and the coordinates of the preset space. The embodiments of the present disclosure can improve the accuracy of detecting pedestrian events.

The present disclosure is a continuation of and claims priority under 35 U.S.C. 120 to PCT application No. PCT/CN2020/089071 filed on May 7, 2020, which claims the priority of Chinese Patent Application No. 201911192848.8, filed with the Chinese Patent Office on Nov. 28, 2019 and titled “Detection Method and Device for Pedestrian Events, Electronic Apparatus and Storage Medium”, all of which are incorporated herein by reference in entirety.

### TECHNICAL FIELD

The present disclosure relates to the field of computer technology, and particularly to a detection method and device for pedestrian events, an electronic apparatus and a storage medium.

### BACKGROUND

With the rise of smart cities, high-definition video is applied in more and more scenarios, wherein detection of pedestrian events in different scenarios is an important aspect. Obviously, it is impossible to detect target information from massive video information only by human inspection. With increasing demands for smart cities, there is an urgent need to develop a technology of automatically detecting pedestrian events.

### SUMMARY

The present disclosure provides a technical solution concerning detection of pedestrian events.

According to one aspect of the present disclosure, there is provided a method of detecting a pedestrian event, comprising:

acquiring coordinates of a target pedestrian in multi-frame to-be-processed images;

acquiring coordinates of a preset space; and

determining a pedestrian event occurring to the target pedestrian in the preset space according to the coordinates of the target pedestrian in the multi-frame to-be-processed images and the coordinates of the preset space.

According to one aspect of the present disclosure, there is provided a pedestrian event detection device, comprising:

a first acquiring module, configured to acquire coordinates of a target pedestrian in multi-frame to-be-processed images;

a second acquiring module, configured to acquire coordinates of a preset space; and

a first determining module, configured to determine a pedestrian event occurring to the target pedestrian in the preset space according to the coordinates of the target pedestrian in the multi-frame to-be-processed images and the coordinates of the preset space.

According to one aspect of the present disclosure, there is provided an electronic apparatus comprising: one or more processors; and a memory configured to store executable instructions; wherein the one or more processors are configured to invoke the executable instructions stored in the memory so as to execute the afore-mentioned method.

According to one aspect of the present disclosure, there is provided a computer-readable storing medium having computer program instructions stored thereon, wherein the computer program instructions, when executed by the processors, implement the afore-mentioned method.

According to one aspect of the present disclosure, there is provided a computer program including a computer-readable code, wherein when the computer-readable code operates in an electronic apparatus, a processor of the electronic apparatus implements the afore-mentioned method.

It should be understood that the general description above and the detailed description below are merely exemplary and explanatory, instead of restricting the present disclosure.

Additional features and aspects of the present disclosure will become apparent from the following detailed description of exemplary embodiments with reference to the attached drawings.

### BRIEF DESCRIPTION OF THE DRAWINGS

The drawings herein, which are incorporated into and constitute a part of the specification, together with the specification, illustrate embodiments consistent with the present disclosure, and are used for explaining the technical solutions of the present disclosure.

FIG. 1 shows a flowchart of a pedestrian event detection method provided by an embodiment of the present disclosure.

FIG. 2 shows a schematic diagram of a pedestrian cross-line event in the pedestrian event detection method provided by an embodiment of the present disclosure.

FIG. 3 shows a schematic diagram of a pedestrian cross-line event in a preset direction in the pedestrian event detection method provided by an embodiment of the present disclosure.

FIG. 4 shows a schematic diagram of an application scenario of the pedestrian event detection method provided by an embodiment of the present disclosure.

FIG. 5 shows a block diagram of a pedestrian event detection device provided by an embodiment of the present disclosure.

FIG. 6 shows a block diagram of an electronic apparatus 800 provided by an embodiment of the present disclosure.

FIG. 7 shows a block diagram of an electronic apparatus 1900 provided by an embodiment of the present disclosure.

### DETAILED DESCRIPTION

Various exemplary examples, features and aspects of the present disclosure will be described in detail below with reference to the drawings. The same reference numerals in the drawings represent parts having the same or similar functions. Although various aspects of the embodiments are shown in the drawings, it is not necessary to draw the drawings to scale unless otherwise specified.

The specific term “exemplary” here means “being used as an instance or example, or being explanatory”. Any “exemplary” embodiment given here is not necessarily interpreted as being superior to or better than other embodiments.

The term “and/or” used herein is merely an association relationship describing associated objects, and represents three possible relationships, for example, A and/or B may represent the following three cases: A exists alone, A and B exist at the same time, and B exists alone. In addition, the term “at least one” used herein means any one of a plurality of listed items or any combination of at least two of a plurality of listed items, for example, “including at least one of A, B and C” may mean including any one or more elements selected from the group consisting of A, B and C.

In addition, in order to better explain the present disclosure, numerous specific details are given in the specific embodiments below. A person skilled in the art should understand that the present disclosure can still be implemented even without some of those details. In some examples, methods, means, units and circuits well known to a person skilled in the art are not described in detail so as to highlight the principle of the present disclosure.

In related art, there are basically two methods for detecting pedestrian events. One is the conventional temperature detection method or electronic coil detection method, which has low reliability, poor scalability, and inconvenient installation and maintenance. The other is a video-based detection method, which uses conventional image processing and pattern recognition methods such as background difference and binary segmentation. However, its detection rate of pedestrians is low in a scenario where the video background is complicated, so the detection accuracy of pedestrian events is also low.

In the embodiments of the present disclosure, the coordinates of the preset space is acquired by acquiring the coordinates of the target pedestrian in multi-frame to-be-processed images, and pedestrian events of the target pedestrian in the preset space are determined according to the coordinates of the target pedestrian in the multi-frame to-be-processed images and the coordinates of the preset space, thereby enhancing detection accuracy of pedestrian events.

The embodiments of the present disclosure can be applied to any application scenario that requires pedestrian event detection. For example, the embodiments of the present disclosure can be applied to scenarios such as subway stations, train stations, roads, shopping malls, stations, prisons, squares, or sentry boxes of companies.

The embodiments of the present disclosure will be described below with reference to the drawings of the embodiments of the present disclosure.

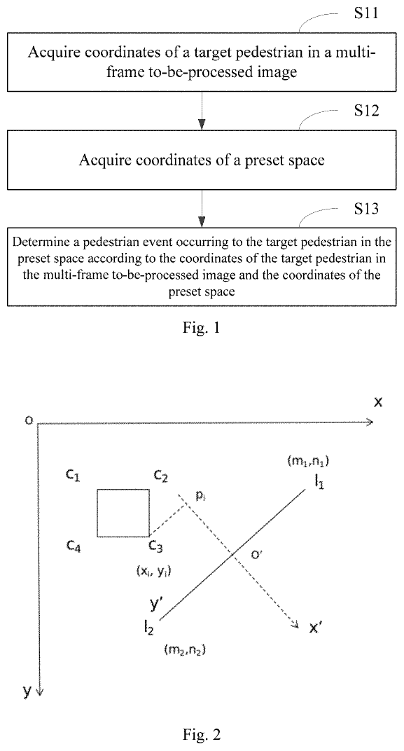

FIG. 1 shows a flowchart of a pedestrian event detection method provided by an embodiment of the present disclosure. The executor of the pedestrian event detection method may be a pedestrian event detection device. For instance, the pedestrian event detection method may be executed by a terminal apparatus or a server or other processing apparatuses, wherein the terminal apparatus may be a User Equipment (UE), a mobile apparatus, a user terminal, a terminal, a cellular phone, a cordless phone, a Personal Digital Assistant (PDA), a handheld apparatus, a computing apparatus, a vehicle-mounted apparatus, or a wearable device, etc. In some possible implementations, the pedestrian event detection method may be implemented by means of invoking, by a processor, computer-readable instructions stored in the memory. As shown in FIG. 1, the pedestrian event detection method comprises steps S11 to S13.

In step S11, the coordinates of a target pedestrian in multi-frame to-be-processed images are acquired.

The executor of the embodiments of the present disclosure may be a server. The server may be connected to a camera capable of sending a collected video stream to the server. The server may use the multi-frame video images containing the same pedestrian in the video stream sent by the camera as multi-frame to-be-processed images, and the same pedestrian contained in the multi-frame to-be-processed images is the target pedestrian. It should be understood that the above multi-frame video images may be multi-frame continuous video images, or may not be continuous video images. The number of target pedestrians may be one or more, that is, the multi-frame to-be-processed images may contain one or more identical pedestrians.

For example, suppose that a video stream captured by a camera includes 10 frames of images, and a pedestrian A is contained in all of the first frame image, the second frame image, the third frame image, the sixth frame image, the eighth frame image, and the ninth frame image, then the first frame image, the second frame image, the third frame image, the sixth frame image, the eighth frame image, and the ninth frame image can be used as multi-frame to-be-processed images, wherein the timestamp of the first frame image is smaller than that of the second frame image, and the timestamp of the second frame image is smaller than that of the third frame image, and analogically, the timestamp of the ninth frame image is smaller than that of the tenth frame image.

In one possible implementation, acquiring coordinates of a target pedestrian in multi-frame to-be-processed images comprises: acquiring coordinates of the target pedestrian in the multi-frame to-be-processed images by means of a deep neural network. In this implementation, use of the deep neural network to acquire coordinates of the target pedestrian in multi-frame to-be-processed images enables coordinates of a target pedestrian to be acquired more rapidly and more accurately.

In the embodiments of the present disclosure, the server may perform pedestrian detection on to-be-processed images through any pedestrian detection algorithm, wherein the pedestrian detection algorithm may be the “you only look once” algorithm (YOLO), the deformable part model algorithm (DMP), the single shot multiBox detector algorithm (SSD), the Faster-RCNN algorithm or the like, which is not specifically limited in the present disclosure.

Pedestrian detection is performed on each frame of the to-be-processed images by a pedestrian detection algorithm, thereby obtaining the coordinates of the target pedestrian in each frame of the to-be-processed images. The coordinates of the target pedestrian may be the coordinates of the bounding box containing (surrounding) the target pedestrian, or the coordinates of the target pedestrian may be the coordinates of the geometric center of the bounding box of the target pedestrian, or the coordinates of the target pedestrian may also be the coordinates of a key point on the outline of the target pedestrian, and all of the above coordinates refer to the coordinates in the coordinate system of the to-be-processed images.

In one possible implementation, each frame of the to-be-processed images contains a timestamp representing the acquisition time of the to-be-processed images. The coordinates of the target pedestrian in each frame of the to-be-processed images can be ranked in the order from small to large timestamps of the to-be-processed images, thereby obtaining the coordinate sequence of the target pedestrian, i.e. the coordinates of the target pedestrian at different times. The relationship between the coordinates of the target pedestrian in the multi-frame to-be-processed images and the time may be determined according to the coordinates of the target pedestrian in the multi-frame to-be-processed images and the timestamps of the multi-frame to-be-processed images. The relationship between the coordinates of the target pedestrian in the multi-frame to-be-processed images and the time may include the coordinates of the target pedestrian at any moment.

In one possible implementation, the coordinates of the target pedestrian in the multi-frame to-be-processed images may be curve-fitted to obtain the relationship between the coordinates of the target pedestrian in the multi-frame to-be-processed images and the time, thereby obtaining the movement trajectory of the target pedestrian, wherein curve fitting is a data processing method for approximately depicting or illustrating the relationship among the coordinates represented by a plurality of discrete points on a plane with continuous curves. In other words, the relationship between the coordinates of the target pedestrian in the multi-frame to-be-processed images and the time can be obtained by curve-fitting the coordinates of the bounding box in the multi-frame to-be-processed images, thereby obtaining the coordinates of the target pedestrian at any moment between any two frames of the to-be-processed images.

In one example, Hungarian algorithm (maximum matching in bipartite graph) and Kalman filtering may be used in the processing to determine the relationship between the coordinates of the target pedestrian in the multi-frame to-be-processed images and the time. The Hungarian algorithm is used for matching the target pedestrians in two adjacent frames of the to-be-processed images, namely, matching the target pedestrian in the latter frame to the former frame, and combining multiple frames to form a coordinate-and-time sequence, thereby obtaining the relationship between the coordinates of the target pedestrian and the time. The main function of Kalman filtering is filtering and noise removal for the movement trajectory of each target pedestrian, so as to improve the accuracy of the outputted movement trajectory and enhance the matching accuracy of Hungarian algorithm.

In step S12, coordinates of the preset space are acquired.

In the embodiment of the present disclosure, the preset space may be a one-dimensional space, a two-dimensional space or a three-dimensional space. For example, the preset space may include a preset line and/or a preset region. The preset line may be a one-dimensional space, and the preset region may be a two-dimensional space or a three-dimensional space.

In one possible implementation, the user can select two preset points in the captured area of a camera, and use the line connecting the two preset points as the preset line. In another possible implementation, the user may sequentially select a plurality of preset points in the captured area of the camera and connect the plurality of preset points in sequence to obtain a closed polygon consisting of the plurality of preset points, and use the region contained in the polygon as a preset region.

In step S13, a pedestrian event occurring to the target pedestrian in the preset space is determined according to the coordinates of the target pedestrian in the multi-frame to-be-processed images and the coordinates of the preset space.

In the embodiments of the present disclosure, the pedestrian event may include one or more of a pedestrian cross-line event, a pedestrian stay event, a pedestrian wandering event, a pedestrian invasion event, and the like. The pedestrian cross-line event represents the event where a pedestrian crosses a preset line, the pedestrian stay event represents the event where a pedestrian stays within a preset region, the pedestrian wandering event represents the event where a pedestrian wanders within the preset region, and the pedestrian invasion event represents the event where a pedestrian enters the preset region.

In one possible implementation, the preset space includes a preset line, and the pedestrian event includes a pedestrian cross-line event. Based on this implementation, it is possible to detect the pedestrian cross-line event, thereby acquiring statistics on for example the flow of people at subway stations, at train stations, and in squares, and the customer flow in shopping malls.

As an example of this implementation, the pedestrian cross-line event can be divided into two types: a non-directional cross-line event and a directional cross-line event. The direction of crossing the line is not taken into consideration in the non-directional cross-line event, and a pedestrian cross-line event occurs as long as the pedestrian crosses the preset line from one side to the other; and the cross-line direction is taken into consideration in the directional cross-line event, and it is detected whether the pedestrian crosses the line in a preset direction.

In one possible implementation, determining a pedestrian event occurring to the target pedestrian in the preset space according to the coordinates of the target pedestrian in the multi-frame to-be-processed images and the coordinates of the preset space comprises: determining a first coordinate axis perpendicular to the preset line according to the coordinates of the preset line; determining projected coordinates of the target pedestrian in the multi-frame to-be-processed images on the first coordinate axis according to the coordinates of the target pedestrian in the multi-frame to-be-processed images; and determining that the target pedestrian performs the pedestrian cross-line event relative to the preset line in the case where any two of the projected coordinates are on both sides of a target point respectively, wherein the target point represents an intersection of the first coordinate axis and the preset line.

For instance, if the preset line serves as a second coordinate axis, the target point will be the intersection of the first coordinate axis and the second coordinate axis, i.e. the origin.

According to this implementation, it is possible to detect a pedestrian cross-line event in a non-directional manner, thereby acquiring statistics such as the flow of people at subway stations, at train stations, and in squares, and the customer flow in shopping malls.

In this implementation, the coordinates of the preset line can be represented by the coordinates of two points on the preset line. FIG. 2 shows a schematic diagram of a pedestrian cross-line event in the pedestrian event detection method provided by an embodiment of the present disclosure. As shown in FIG. 2, coordinates of the preset line can be represented by the coordinates of two points, i.e. l₁ and l₂, on the preset line, where the coordinates of the point l₁ is (m₁, n₁), and the coordinates of the point l₂ is (m₂, n₂). The direction vector of the preset line can be represented as

$$\frac{( {m}_{2} - {m}_{1} , {n}_{2} - {n}_{1} )}{\sqrt{{( {m}_{2} - {m}_{1} )}^{2} + {( {n}_{2} - {n}_{1} )}^{2}}} .$$

The direction vector n¹ of the perpendicular line of the preset line can be determined by Formula 1:

$${n}^{r} = \frac{1}{\sqrt{{( {m}_{2} - {m}_{1} )}^{2} + {( {n}_{2} - {n}_{1} )}^{2}}} [ \begin{matrix}cos θ & sin θ \\ - sin θ & cos θ\end{matrix} ] ( \begin{matrix}{m}_{2} - {m}_{1} \\ {n}_{2} - {n}_{1}\end{matrix} ) , \\ namely , \\ {n}^{r} = \frac{( {n}_{2} - {n}_{1} , {m}_{2} - {m}_{1} )}{\sqrt{{( {m}_{2} - {m}_{1} )}^{2} + {( {n}_{2} - {n}_{1} )}^{2}}} . \qquad Formula 1$$

In this implementation, the first coordinate axis may be the x′-axis in FIG. 2, and the direction vector of the present line can serve as the y′-axis.

The coordinates of the target pedestrian may be the vertex coordinates of the bounding box of the target pedestrian. In FIG. 2, cᵢ represents a vertex of the bounding box of the target pedestrian, and the coordinates of cᵢ may be represented as (xᵢ, yᵢ), 1≤i≤n, e.g., n=4. In FIG. 2, the subscripts of the vertexes of the bounding box of the target pedestrian are arranged clockwise. For the sake of clarity, FIG. 2 shows a schematic diagram of the bounding box of the target pedestrian by taking a rectangle as an example. It will be appreciated by a person skilled in the art that the bounding box of the target pedestrian may be of any shape. The projected coordinates pᵢ of cᵢ on x′-axis may be represented by Formula 2:

pᵢ=(xᵢ,yᵢ)·n¹−(m₁,n₁)n¹ Formula 2.

For one frame of the to-be-processed images, if the vertexes of the bounding box of the target pedestrian in the to-be-processed image satisfy min(p₁,L,pₙ)≤0 and max(p₁,L, pₙ)≥0, it can be determined that the target pedestrian performs the pedestrian cross-line event relative to the preset line, where the equal sign in the formula means that the case where the vertex of the bounding box is on the preset line is also considered as the cross-line event. As for multi-frame to-be-processed images, if the vertexes of the bounding boxes of the target pedestrian in two adjacent frames of the to-be-processed images satisfy pᵢ<0 and qᵢ>0, or pᵢ>0 and qᵢ<0, it can be determined that the target pedestrian performs the pedestrian cross-line event relative to the preset line, wherein 1≤i≤n, and pᵢ and qᵢ respectively represent vertexes of the bounding boxes of the target pedestrian in two adjacent frames of the to-be-processed images.

In one possible implementation, determining that the target pedestrian performs the pedestrian cross-line event relative to the preset line in the case where any two of the projected coordinates are respectively on both sides of a target point comprises: determining an angle between a vector of a preset direction and a direction vector of the first coordinate axis; determining that the target pedestrian performs a pedestrian cross-line event in the preset direction relative to the preset line in the case where the angle is smaller than 90°, first projected coordinates and second projected coordinates of the projected coordinates are on both sides of the target point respectively, a timestamp of a to-be-processed image corresponding to the first projected coordinates is earlier than that of a to-be-processed image corresponding to the second projected coordinates, and the first projected coordinates are smaller than the second projected coordinates; and/or determining that the target pedestrian performs a pedestrian cross-line event in the preset direction relative to the preset line in the case where the angle is greater than 90°, first projected coordinates and second projected coordinates of the projected coordinates are on both sides of the target point respectively, a timestamp of a to-be-processed image corresponding to the first projected coordinates is earlier than that of a to-be-processed image corresponding to the second projected coordinates, and the first projected coordinates are larger than the second projected coordinates.

Based on this implementation, it is possible to detect the event of a pedestrian crossing a preset line in a preset direction, thereby acquiring statistics such as the number of people leaving a subway station and the number of people entering a subway station.

In this implementation, the direction vector of the first coordinate axis may be parallel to the first coordinate axis and may point to the positive direction of the first coordinate axis.

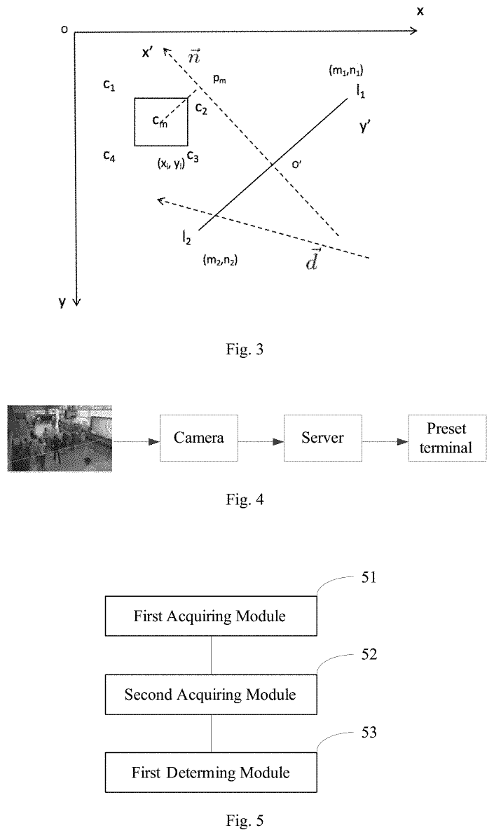

FIG. 3 shows a schematic diagram of a pedestrian cross-line event in a preset direction in the pedestrian event detection method provided by an embodiment of the present disclosure. In the example shown in FIG. 3, the direction vector of the preset direction can be shown as d¹, and the direction vector n¹ of the perpendicular line of the preset line can be obtained by the method described above. In one example, if d¹·n¹<0, let n¹=−n¹, so that the angle between the direction vector of the perpendicular line of the preset line and the direction vector of the preset direction is smaller than 90°. In one example, Formula 3 can be used for determining the geometric center cₘ of the bounding box of the target pedestrian:

$${c}_{m} = {\sum }_{i = 1}^{n} ( {x}_{i} , {y}_{i} ) . \qquad Formula 3$$

It is considered that the target pedestrian crosses the preset line in the preset direction, when the geometric center crosses the preset line from one side to the other in a direction consistent with the preset direction. If the direction vector of the perpendicular line of the preset line is defined as the x′-axis, the projected coordinates pₘ of the geometric center cₘ on the x′-axis can be represented by Formula 4:

pₘ=(xₘ,yₘ)·n¹·(m₁,n₁)n¹ Formula 4.

For multi-frame to-be-processed images, if two frames of the to-be-processed images k and l satisfy pₘₖ<0, pₘₗ>0, and Tₖ<Tₗ, it can be determined that the target pedestrian crosses the preset line in the preset direction, wherein k and l represent the sequence numbers of the two frames of the to-be-processed images, pₘₖ represents the projected coordinates of the geometric center of the bounding box of the target pedestrian in the to-be-processed image k on the x′-axis, pₘₗ represents the projected coordinates of the geometric center of the bounding box of the target pedestrian in the to-be-processed image l on the x′-axis, Tₖ represents the timestamp of the to-be-processed image k, and Tₗ represents the timestamp of the to-be-processed image l.

In one possible implementation, the preset space includes a preset region, and the pedestrian event includes one or more of the pedestrian stay event, the pedestrian wandering event and the pedestrian invasion event. Based on this implementation, it is possible to detect one or more of the events where the pedestrian stays in the present region, the pedestrian wanders in the preset region and the pedestrian enters the preset region.

For example, exits of a subway station, airports, etc. are expected to be unobstructed, and no stay or wandering of people is expected, so a region at the exit of the subway station or the airport, etc. can be designated as the preset region corresponding to the pedestrian stay event or the pedestrian wandering event.

As another example, in some controlled regions, such as military regions or temporary site protection regions, since no invasion is allowed, these regions can be used as the preset regions corresponding to pedestrian invasion events.

In one possible implementation, determining a pedestrian event occurring to the target pedestrian in the preset region according to the coordinates of the target pedestrian in the multi-frame to-be-processed images and the coordinates of the preset space comprises: determining one or more of the pedestrian stay event, the pedestrian wandering event and the pedestrian invasion event occurring to the target pedestrian in the case of determining, according to the coordinates of the target pedestrian in the multi-frame to-be-processed images and the coordinates of the preset space, that one or more of the following conditions are satisfied: the target pedestrian is in the preset region; the staying time of the target pedestrian in the preset region is greater than or equal to the time threshold; and the cumulative moving distance of the target pedestrian within the staying time is greater than or equal to the distance threshold.

For instance, when it is determined, according to the coordinates of the target pedestrian in the multi-frame to-be-processed images and the coordinates of the preset space, that the target pedestrian is in the preset region, it can be determined that the target pedestrian performs a pedestrian invasion event in the preset region; when it is determined, according to the coordinates of the target pedestrian in the multi-frame to-be-processed images and the coordinates of the preset space, that the staying time of the target pedestrian in the preset region is greater than or equal to the time threshold, it can be determined that the target pedestrian performs a pedestrian wandering event in the preset region; and when it is determined, according to the coordinates of the target pedestrian in the multi-frame to-be-processed images and the coordinates of the preset space, that the staying time of the target pedestrian in the preset region is greater than or equal to the time threshold and that the cumulative moving distance of the target pedestrian in the preset region is greater than or equal to the distance threshold, it can be determined that the target pedestrian performs the pedestrian wandering event in the preset region.

With this implementation, one or more of the pedestrian stay event, the pedestrian wandering event, and the pedestrian invasion event can be detected according to the conditions satisfied by the coordinates of the target pedestrian in the multi-frame to-be-processed images and the coordinates of the preset space.

In one possible implementation, the preset space includes a preset region, and the pedestrian event includes a pedestrian stay event; determining a pedestrian event occurring to the target pedestrian in the preset space according to the coordinates of the target pedestrian in the multi-frame to-be-processed images and the coordinates of the preset space comprises: determining staying time of the target pedestrian in the preset region according to the coordinates of the target pedestrian in the multi-frame to-be-processed images and the coordinates of the preset region; and determining that the target pedestrian performs the pedestrian stay event in the preset region in the case where the staying time is greater than or equal to a time threshold.

Based on this implementation, it is possible to determine that a target pedestrian performs a pedestrian stay event in a preset region in the case where the staying time of the target pedestrian in the preset region is greater than or equal to a time threshold, and as a result, it is possible to detect timely that the pedestrian is staying in the application scenarios where the pedestrian stay is not desirable, so that the staff can notify the target pedestrian in time to stop staying in the preset region.

In one possible implementation, the preset space includes a preset region, and the pedestrian event includes a pedestrian wandering event; determining a pedestrian event occurring to the target pedestrian in the preset space according to the coordinates of the target pedestrian in the multi-frame to-be-processed images and the coordinates of the preset space comprises: determining staying time of the target pedestrian in the preset region according to the coordinates of the target pedestrian in the multi-frame to-be-processed images and the coordinates of the preset region; determining a cumulative moving distance of the target pedestrian within the staying time; and determining that the target pedestrian performs the pedestrian wandering event in the preset region in the case where the staying time is greater than or equal to a time threshold and the cumulative moving distance is greater than or equal to a distance threshold.

For instance, when the preset region is a subway station hall and the distance threshold is 3000 meters, if the staying time of the target pedestrian in the subway station hall is greater than or equal to the time threshold, and the cumulative moving distance is greater than or equal to 3000 meters, it can be determined that the target pedestrian performs a pedestrian wandering event in the subway station hall.

Based on this implementation, it is possible to determine that a target pedestrian performs a pedestrian wandering event in a preset region, in the case where the staying time of the target pedestrian in the preset region is greater than or equal to a time threshold and the cumulative moving distance is greater than or equal to a distance threshold. As a result, it is possible to detect wandering of the pedestrian timely in the application scenarios where the wandering of pedestrians is not desirable, so that the staff can notify the target pedestrian in time to stop wandering in the preset region.

In one possible implementation, determining staying time of the target pedestrian in the preset region according to the coordinates of the target pedestrian in the multi-frame to-be-processed images and the coordinates of the preset region comprises: determining a first timestamp of a to-be-processed image when the target pedestrian appears in the preset region for the first time and a second timestamp of a to-be-processed image when the target pedestrian appears in the preset region for the last time according to the coordinates of the target pedestrian in the multi-frame to-be-processed images, the coordinates of the preset region and the timestamp of the multi-frame to-be-processed images; and determining the time interval between the second timestamp and the first timestamp as the staying time of the target pedestrian in the preset region.

In this implementation, it is fine not to consider whether the target pedestrian leaves the preset region midway, but only to consider whether the time interval between two appearances of the target pedestrian in the preset region is greater than or equal to the time threshold. As a result, this implementation is applicable to the scenarios in which whether the target pedestrian leaves the preset region midway is not considered.

In one example, if the target pedestrian in any two frames of the multi-frame to-be-processed images is in the preset region, and the time interval between the timestamps of the two frames of the to-be-processed images is greater than or equal to the time threshold, it can be determined that the target pedestrian performs a pedestrian stay event in the preset region. For example, the target pedestrian in a to-be-processed image a is in the preset region, the target pedestrian in a to-be-processed image b is in the preset region, the timestamp of the to-be-processed image a is Tₐ, the timestamp of the to-be-processed image b is T_{b}, and the time threshold is T_{threshold}; if T_{b}−Tₐ≥T_{threshold}, it can be determined that the target pedestrian performs a pedestrian stay event in the preset region.

In an example, the timestamp when the target pedestrian appears in the preset region for the first time may be recorded as a reference timestamp, and if the time interval between the timestamp when the target pedestrian appears again in the preset region and the reference timestamp is greater than or equal to the time threshold, it can be determined that the target pedestrian performs a pedestrian stay event in the preset region.

In an example, if the target pedestrian in any two frames of the multi-frame to-be-processed images is in a preset region, the time interval between the timestamps of the two frames of the to-be-processed images is greater than or equal to the time threshold, and the cumulative moving distance of the target pedestrian in the preset region is greater than or equal to the distance threshold, it can be determined that the target pedestrian performs a pedestrian wandering event in the preset region.

In one possible implementation, determining staying time of the target pedestrian in the preset region according to the coordinates of the target pedestrian in the multi-frame to-be-processed images and the coordinates of the preset region comprises: determining a number of images in which the target pedestrian is in the preset region in the multi-frame to-be-processed images according to the coordinates of the target pedestrian in the multi-frame to-be-processed images and the coordinates of the preset region; and determining a product of the number of images and the duration of each frame of the to-be-processed images as a cumulative duration of the target pedestrian in the preset region, and taking the cumulative duration as the staying time of the target pedestrian in the preset region. Based on this implementation, it is possible to rapidly and accurately determine the cumulative duration of the target pedestrian in the preset region.

This implementation can be applied to the application scenarios not caring whether the target pedestrian leaves the preset region midway but considering the cumulative duration of the target pedestrian in the preset region.

For instance, the product of the number of images and the duration of each frame of the to-be-processed images may be used as the cumulative duration of the target pedestrian in the preset region. For example, if the number of images is K and the duration of each image to be processed is Tₒ, the cumulative duration may be equal to KTₒ.

In one possible implementation, determining staying time of the target pedestrian in the preset region according to the coordinates of the target pedestrian in the multi-frame to-be-processed images and the coordinates of the preset region comprises: determining a maximum number of continuous images in which the target pedestrian is in the preset region in the multi-frame to-be-processed images according to the coordinates of the target pedestrian in the multi-frame to-be-processed images and the coordinates of the preset region; and determining a product of the maximum number of continuous images and a duration of each frame of the to-be-processed images as a maximum duration of the target pedestrian in the preset region, and taking the maximum duration as the staying time of the target pedestrian in the preset region.

In this implementation, whether the target pedestrian leaves the preset region midway is taken into consideration, and the duration will be recalculated if the target pedestrian leaves the preset region midway. This implementation is applicable to the scenarios in which whether the target pedestrian leaves the preset region midway is an issue.

In one possible implementation, determining a cumulative moving distance of the target pedestrian within the staying time comprises: determining the to-be-processed images in which the target pedestrian is in the preset region within the staying time as stay images respectively; and obtaining the cumulative moving distance of the target pedestrian within the staying time by accumulating the distances between the coordinates of the target pedestrian in two adjacent frames of the stay images, wherein the distance may be Euclidean distance.

In this implementation, it is possible to consider only the moving distance of the target pedestrian in the preset region. If the target pedestrian leaves the preset region, the moving distance will not be considered. For example, if the target pedestrian is in the preset region in the to-be-processed images 1, 2, 3, and 5, and the target pedestrian is not in the preset region in the to-be-processed image 4, the distance between the coordinates of the target pedestrian in the to-be-processed images 1 and 2, the distance between the coordinates of the target pedestrian in the to-be-processed images 2 and 3, and the distance between the coordinates of the target pedestrian in the to-be-processed images 3 and 5 will be included in the cumulative moving distance, but the distance between the coordinates of the target pedestrian in the to-be-processed images 3 and 4, and the distance between the coordinates of the target pedestrian in the to-be-processed images 4 and 5 will not be included in the cumulative moving distance.

The cumulative moving distance determined in this implementation can better reflect the wandering of the target pedestrian in the preset region, thereby being helpful to enhance the detection accuracy of pedestrian wandering events.

In one possible implementation, the coordinates of the geometric center of the bounding box of the target pedestrian can be determined as the coordinates of the target pedestrian, and whether the target pedestrian is in the preset region can be determined by judging whether the geometric center of the bounding box of the target pedestrian is within the preset region. That is, if the geometric center of the bounding box of the target pedestrian is within the preset region, it can be determined that the target pedestrian is within the preset region; if not, it can be determined that the target pedestrian is not within the preset area.

As an example of this implementation, when the area of the preset region is much larger than that of the bounding box of the target pedestrian, for example, when the ratio of the area of the preset region to the area of the bounding box of the target pedestrian is greater than or equal to a preset ratio, whether the target pedestrian is in the preset region may be determined by judging whether the geometric center of the bounding box of the target pedestrian is within the preset region.

In one possible implementation, the method further comprises: determining, according to the coordinates of the target pedestrian in any to-be-processed image of the multi-frame to-be-processed images and the coordinates of the preset region, an area overlap value of an area where the region the target pedestrian appears in the to-be-processed image overlaps with the preset region; and determining that the target pedestrian in the to-be-processed image is in the preset region when the area overlap value is greater than or equal to an overlap threshold. For instance, the overlap threshold may be 0.5.

In this implementation, whether the target pedestrian is within the preset region is determined according to the area overlap value of the region where the target pedestrian appears and the preset region.

As an example of this implementation, the coordinates of the target pedestrian include the coordinates of a bounding box containing the target pedestrian; and determining, according to the coordinates of the target pedestrian in any to-be-processed image of the multi-frame to-be-processed images and the coordinates of the preset region, an area overlap value of the region where the target pedestrian appears in the to-be-processed image and the preset region comprises: determining a first area of the overlapping region of a region surrounded by the bounding box in the to-be-processed image with the preset region, according to the coordinates of the bounding box of the target pedestrian in any to-be-processed image of the multi-frame to-be-processed images and the coordinates of the preset region; and determining a ratio of the first area to an area of the region contained in the bounding box as the area overlap value.

In this example, the area overlap value can be determined according to the ratio of the area of the overlapping region to the area of the bounding box of the target pedestrian, and the area overlap value determined in this way can better reflect the overlap between the bounding box of the target pedestrian and the preset region, thereby being helpful in more accurate detection of pedestrian events.

As another example of this implementation, the overlapping region of the region contained in the bounding box and the preset region can be directly used as the area overlap value.

As an example of this implementation, whether the target pedestrian is within the preset region may be determined according to the overlap degree of the region contained in the bounding box of the target pedestrian and the preset region in the case where the area of the preset region is close to the area of the bounding box of the target pedestrian, for instance, where the ratio of the area of the preset region to the area of the bounding box of the target pedestrian is less than the preset ratio.

In one possible implementation, the preset space includes a preset region, and the pedestrian event includes a pedestrian invasion event; and determining a pedestrian event occurring to the target pedestrian in the preset space according to the coordinates of the target pedestrian in the multi-frame to-be-processed images and the coordinates of the preset space comprises: acquiring an invasion sensitivity coefficient; determining a second area of the overlapping region of the region contained in the bounding box in the to-be-processed image and the preset region according to the coordinates of the target pedestrian in any to-be-processed image of the multi-frame to-be-processed images and the coordinates of the preset region; and determining that the target pedestrian performs the pedestrian invasion event in the preset region in the case where a ratio of the second area to the area of the region contained in the bounding box is greater than the invasion sensitivity coefficient.

In this implementation, the invasion sensitivity coefficient may represent the sensitivity to a pedestrian invasion into the preset region. In one example, the invasion sensitivity coefficient is negatively correlated with the sensitivity to the pedestrian invasion into the preset region, namely, the smaller is the invasion sensitivity coefficient, the greater is the sensitivity to the pedestrian invasion into the preset region. The invasion sensitivity coefficient may be greater than or equal to 0 and less than or equal to 1. An invasion sensitivity coefficient of 0 means that the target pedestrian is considered to invade the preset region as long as any part of the bounding box of the target pedestrian enters the preset region, that is, the target pedestrian is determined to perform a pedestrian invasion event in the preset region. An invasion sensitivity coefficient of 1 indicates that the target pedestrian is considered to invade the preset region only if the bounding box of the target pedestrian is completely within the preset region. For example, the invasion sensitivity coefficient can usually be set to 0.5; for dangerous regions, such as maintenance sites and dangerous water areas, the invasion sensitivity coefficient may be set as 0; for roadblocks and other less sensitive regions, the invasion sensitivity coefficient may be set as 1.

Based on this implementation, it is possible to detect timely any pedestrian is invading in the application scenarios where pedestrian invasion is not desirable, so that the staff can timely notify the target pedestrian to leave the preset region.

In one possible implementation, a part of the bounding box of the target pedestrian (for example, the lower half of the bounding box of the target pedestrian) can be determined as the region where the target pedestrian appears. A third area of the region where the target pedestrian appears and the preset area overlap in the to-be-processed image is determined, and in the case where the ratio of the third area to the area of the region where the target pedestrian appears is greater than the invasion sensitivity coefficient, it is determined that the target pedestrian performs a pedestrian invasion event in the preset area.

In one possible implementation, the method further comprises: issuing an alarm message in the case of detecting that the target pedestrian performs the pedestrian event in the preset space.

In this implementation, an alarm message will be issued in the case of detecting that the target pedestrian performs the pedestrian event in the preset space, so that the staff can detect the pedestrian event in time and take timely measures.

In one possible implementation, in order to reduce the probability of frequent alarms, a cooling time can be set. Within the cooling time counted from the moment when the alarm message is issued, no alarm will be sent even if the alarm conditions are met. The cooling time can be adaptively arranged according to the requirements for the alarm sensitivity in specific scenarios.

In one possible implementation, the method further comprises: extracting attribute information of the target pedestrian in the case of detecting that the target pedestrian performs the pedestrian event in the preset space; and outputting the attribute information of the target pedestrian.

In this implementation, the attribute information of the target pedestrian may be information indicating the appearance characteristics or attributes of the target pedestrian. For example, the attribute information of the target pedestrian may include one or more of the target pedestrian's gender, age range, clothing type, clothing color, hairstyle, hair color, style of shoes, color of shoes, whether or not to bring a bag, bag type, bag color, whether or not to wear a hat, whether or not to wear glasses, whether or not to bring an umbrella, the color of the umbrella and so on.

As an example of this implementation, the deep learning technology can be adopted to identify the attributes of the target pedestrian, so as to obtain the attribute information of the target pedestrian.

As an example of this implementation, outputting the attribute information of the target pedestrian may include: sending the attribute information of the target pedestrian to a preset terminal. In this example, while the attribute information of the target pedestrian is sent to the preset terminal, the type of the pedestrian event occurring to the target pedestrian in the preset space may also be sent to the preset terminal. For example, in the case that the preset space is the exit region of a subway station, and that the preset terminal is the mobile phones of the subway station staff, if it is detected that the target pedestrian A performs a pedestrian stay event in the exit region of the subway station, the attribute information of the target pedestrian A, as well as the type of pedestrian event occurring to the target pedestrian A in the exit region of the subway station, e.g., “a male pedestrian wearing a yellow coat, black pants, white shoes, a cap and glasses is staying at Exit C of the subway station”, will be sent to the phone of the subway station staff, so as to help the subway station staff rapidly find the target pedestrian A in the exit region of the subway station and inform the target pedestrian A that he should not stay there.

In this implementation, the attribute information of the target pedestrian will be output in the case of detecting that the target pedestrian performs the pedestrian event in the preset space, which helps the staff to find the target pedestrian.

FIG. 4 shows a schematic diagram of application scenarios of the pedestrian event detection method provided by an embodiment of the present disclosure. As shown in FIG. 4, videos can be collected by the camera and processed by a server so as to determine whether a pedestrian event occurs. If the server determines that a pedestrian event occurs, it will send an alarm message to the preset terminal, and the preset terminal will output the alarm information on the alarm display page, so that the staff can receive the alarm message in time.

For different scenarios and applications, detection models for different pedestrian events may be arranged, for instance, it is possible to arrange detection models for one or more pedestrian events including a pedestrian cross-line event, a pedestrian stay event, a pedestrian wandering event, and a pedestrian invasion event.

This example of the present disclosure provides a pedestrian event detection method with a high detection rate, a low false detection rate, high real-time performance and reliability, and can be applied to large-scale and complex scenarios. It is applicable to the pedestrian event detection under different scenarios.

It should be understood that without violating the principle and the logics, the above method embodiments described in the present disclosure may be combined with one another to form a combined embodiment, which, due to limited space, will not be repeatedly described in the present disclosure.

A person skilled in the art may understand that, in the foregoing method according to specific embodiments, the order of describing the steps does not means a strict order of execution that imposes any limitation on the implementation process. Rather, a specific order of execution of the steps should depend on the functions and possible inherent logics of the steps.

In addition, the present disclosure further provides a pedestrian event detection device, an electronic apparatus, a computer-readable storage medium and a program, all of which can be used to implement any of the pedestrian event detection methods provided in the present disclosure. Corresponding technical solutions and descriptions which will not be repeated, reference may be made to the corresponding descriptions of the method.

FIG. 5 shows a block diagram of a pedestrian event detection device provided by an embodiment of the present disclosure. As shown in FIG. 5, the pedestrian event detection device comprises: a first acquiring module 51, configured to acquire coordinates of a target pedestrian in multi-frame to-be-processed images; a second acquiring module 52, configured to acquire coordinates of a preset space; and a first determining module 53, configured to determine a pedestrian event occurring to the target pedestrian in the preset space according to the coordinates of the target pedestrian in the multi-frame to-be-processed images and the coordinates of the preset space.

In one possible implementation, the first acquiring module 51 is configured to: acquire coordinates of the target pedestrian in the multi-frame to-be-processed images by means of a deep neural network.

In one possible implementation, the preset space includes a preset line, and the pedestrian event includes a pedestrian cross-line event; and the first determining module 53 is configured to: determine a first coordinate axis perpendicular to the preset line according to the coordinates of the preset line; determine projected coordinates of the target pedestrian in the multi-frame to-be-processed images on the first coordinate axis according to the coordinates of the target pedestrian in the multi-frame to-be-processed images; and determine that the target pedestrian performs the pedestrian cross-line event relative to the preset line in the case where any two of the projected coordinates are on both sides of a target point respectively, wherein the target point represents an intersection of the first coordinate axis and the preset line.

In one possible implementation, the first determining module 53 is configured to: determine an angle between a vector of a preset direction and a direction vector of the first coordinate axis; determine that the target pedestrian performs a pedestrian cross-line event in the preset direction relative to the preset line in the case where the angle is smaller than 90°, first projected coordinates and second projected coordinates of the projected coordinates are on both sides of the target point respectively, a timestamp of a to-be-processed image corresponding to the first projected coordinates is earlier than that of a to-be-processed image corresponding to the second projected coordinates, and the first projected coordinates are smaller than the second projected coordinates; and/or determine that the target pedestrian performs a pedestrian cross-line event in the preset direction relative to the preset line in the case where the angle is greater than 90°, first projected coordinates and second projected coordinates of the projected coordinates are on both sides of the target point respectively, a timestamp of a to-be-processed image corresponding to the first projected coordinates is earlier than that of a to-be-processed image corresponding to the second projected coordinates, and the first projected coordinates are larger than the second projected coordinates.

In one possible implementation, the preset space includes a preset region, and the pedestrian event includes a pedestrian stay event; and the first determining module 53 is configured to: determine staying time of the target pedestrian in the preset region according to the coordinates of the target pedestrian in the multi-frame to-be-processed images and the coordinates of the preset region; and determine that the target pedestrian performs the pedestrian stay event in the preset region in the case where the staying time is greater than or equal to a time threshold.

In one possible implementation, the preset space includes a preset region, and the pedestrian event includes a pedestrian wandering event; the first determining module 53 is configured to: determine staying time of the target pedestrian in the preset region according to the coordinates of the target pedestrian in the multi-frame to-be-processed images and the coordinates of the preset region; determine a cumulative moving distance of the target pedestrian within the staying time; and determine that the target pedestrian performs the pedestrian wandering event in the preset region when the staying time is greater than or equal to a time threshold and the cumulative moving distance is greater than or equal to a distance threshold.

In one possible implementation, the first determining module 53 is configured to: determine a first timestamp of a to-be-processed image when the target pedestrian appears in the preset region for the first time and a second timestamp of a to-be-processed image when the target pedestrian appears in the preset region for the last time according to the coordinates of the target pedestrian in the multi-frame to-be-processed images, the coordinates of the preset region and the timestamp of the multi-frame to-be-processed images; and determine the time interval between the second timestamp and the first timestamp as the staying time of the target pedestrian in the preset region.

In one possible implementation, the first determining module 53 is configured to: determine a number of images in which the target pedestrian is in the preset region in the multi-frame to-be-processed images according to the coordinates of the target pedestrian in the multi-frame to-be-processed images and the coordinates of the preset region; and determine a product of the number of images and the duration of each frame of the to-be-processed images as a cumulative duration of the target pedestrian in the preset region, and take the cumulative duration as the staying time of the target pedestrian in the preset region.

In one possible implementation, the first determining module 53 is configured to: determine a maximum number of continuous images in which the target pedestrian is in the preset region in the multi-frame to-be-processed images according to the coordinates of the target pedestrian in the multi-frame to-be-processed images and the coordinates of the preset region; and determine a product of the maximum number of continuous images and a duration of each frame of the to-be-processed images as a maximum duration of the target pedestrian in the preset region, and take the maximum duration as the staying time of the target pedestrian in the preset region.

In one possible implementation, the first determining module 53 is configured to: determine the to-be-processed images in which the target pedestrian is in the preset region within the staying time as stay images respectively; and obtain the cumulative moving distance of the target pedestrian within the staying time by accumulating the distances between the coordinates of the target pedestrian in two adjacent frames of the stay images.

In one possible implementation, the device further comprises: a second determining module configured to determine, according to the coordinates of the target pedestrian in any to-be-processed image of the multi-frame to-be-processed images and the coordinates of the preset region, an area overlap value of the region where the target pedestrian appears in the to-be-processed image and the preset region; and a third determining module configured to determine that the target pedestrian in the to-be-processed image is in the preset region when the area overlap value is greater than or equal to an overlap threshold.

In one possible implementation, the coordinates of the target pedestrian include the coordinates of a bounding box containing the target pedestrian; and the second determining module is configured to: determine a first area of the overlapping region of a region contained in the bounding box in the to-be-processed image and the preset region according to the coordinates of the bounding box of the target pedestrian in any to-be-processed image of the multi-frame to-be-processed images and the coordinates of the preset region; and determine a ratio of the first area to an area of the region contained in the bounding box as the area overlap value.

In one possible implementation, the preset space includes a preset region, and the pedestrian event includes a pedestrian invasion event; and the first determining module 53 is configured to: acquire an invasion sensitivity coefficient; determine a second area of the overlapping region of the region contained in the bounding box in the to-be-processed image and the preset region according to the coordinates of the target pedestrian in any to-be-processed image of the multi-frame to-be-processed images and the coordinates of the preset region; and determine that the target pedestrian performs the pedestrian invasion event in the preset region in the case where a ratio of the second area to the area of the region contained in the bounding box is greater than the invasion sensitivity coefficient.

In one possible implementation, the device further comprises: an alarming module configured to issue an alarm message in the case of detecting that the target pedestrian performs the pedestrian event in the preset space.

In one possible implementation, the device further comprises: an extracting module configured to extract attribute information of the target pedestrian in the case of detecting that the target pedestrian performs the pedestrian event in the preset space; and an output module configured to output the attribute information of the target pedestrian.

In the embodiments of the present disclosure, coordinates of the preset space are acquired by acquiring coordinates of the target pedestrian in multi-frame to-be-processed images, and pedestrian events occurring to the target pedestrian in the preset space are determined according to the coordinates of the target pedestrian in the multi-frame to-be-processed images and the coordinates of the preset space, thereby enhancing detection accuracy of the pedestrian events.

In some embodiments, functions of or modules included in the device provided in the embodiments of the present disclosure may be configured to execute the method described in the foregoing method embodiments. For specific implementation of the functions or modules, reference may be made to descriptions of the foregoing method embodiments. For brevity, details are not described here again.

The embodiments of the present disclosure further provide a computer-readable storage medium having computer program instructions stored thereon, wherein the computer program instructions, when executed by a process, implement the method above. The computer-readable storage medium may be a non-volatile computer-readable storage medium, or a volatile computer-readable storage medium.

The embodiments of the present disclosure further provide a computer program, comprising a computer readable code, wherein when the computer readable code operates in an electronic apparatus, a processor of the electronic apparatus implements the method provided above.

The embodiments of the present disclosure further provide another computer program product, configured to store computer readable instructions, which, when executed, cause a computer to execute operations of the method provided in any one of the above embodiments.

The embodiments of the present disclosure further provide an electronic apparatus, comprising: one or more processors; and a memory configured to store executable instructions; wherein the one or more processors are configured to invoke the executable instructions stored in the memory to execute the afore-mentioned method.

The electronic apparatus may be provided as a terminal, a server, or an apparatus in other forms.

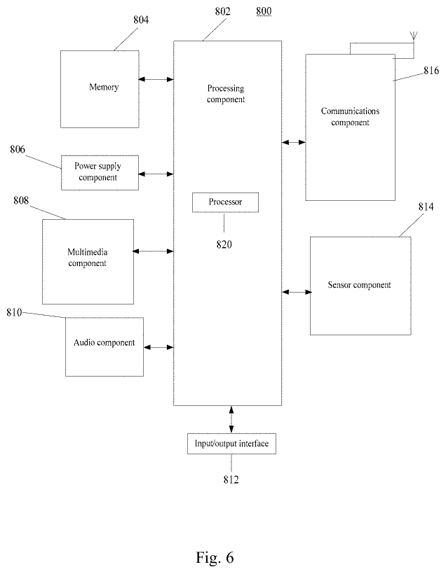

FIG. 6 shows a block diagram of an electronic apparatus 800 provided by an embodiment of the present disclosure. For instance, the electronic apparatus 800 may be a mobile phone, a computer, a digital broadcasting terminal, a message transmitting and receiving apparatus, a game console, a tablet apparatus, a medical apparatus, a fitness apparatus, and a personal digital assistant, and other terminals.

With reference to FIG. 6, electronic apparatus 800 may include one or more of the following components: a processing component 802, a memory 804, a power supply component 806, a multimedia component 808, an audio component 810, an input/output (I/O) interface 812, a sensor component 814 and a communication component 816.

Processing component 802 is configured usually to control the overall operations of the electronic apparatus 800, such as the operations associated with display, telephone calls, data communications, camera operations, and recording operations. Processing component 802 may include one or more processors 820 configured to execute instructions to perform all or part of the steps included in the above-described method. In addition, processing component 802 may include one or more modules configured to facilitate the interaction between processing component 802 and other components. For example, processing component 802 may include a multimedia module configured to facilitate the interaction between multimedia component 808 and processing component 802.

Memory 804 is configured to store various types of data to support the operation of electronic apparatus 800. Examples of such data include instructions for any applications or methods operated on or performed by electronic apparatus 800, contact data, phonebook data, messages, pictures, videos, etc. Memory 804 may be implemented using any type of volatile or non-volatile memory apparatus or a combination thereof, such as a static random access memory (SRAM), an electrically erasable and programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic apparatus 800. Power component 806 may include a power management system, one or more power sources, and any other components associated with the generation, management, and distribution of power in electronic apparatus 800.

Multimedia component 808 includes a screen providing an output interface between electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors configured to sense touches, swipes, and gestures on the touch panel. The touch sensors may sense not only a boundary of a touch or swipe action, but also a period of time and a pressure associated with the touch or swipe action. In some embodiments, multimedia component 808 may include a front camera and/or a rear camera. The front camera and/or the rear camera may receive an external multimedia datum while electronic apparatus 800 is in an operation mode, such as a photographing mode or a video mode. Each of the front camera and the rear camera may be a fixed optical lens system or may have focus and optical zooming capabilities.

Audio component 810 is configured to output and/or input audio signals. For example, audio component 810 may include a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, or buttons, and the like. These buttons may include, but are not limited to, a home button, a volume button, a starting button, and a locking button.

Sensor component 814 includes one or more sensors configured to provide status assessments of various aspects of electronic apparatus 800. For example, sensor component 814 may detect at least one of an open/closed status of electronic apparatus 800, relative positioning of components, e.g., the components being the display and the keypad of electronic apparatus 800. Sensor component 814 may further detect a change of position of electronic apparatus 800 or one component of electronic apparatus 800, presence or absence of contact between the user and electronic apparatus 800, location or acceleration/deceleration of electronic apparatus 800, and a change of temperature of electronic apparatus 800. Sensor component 814 may include a proximity sensor configured to detect the presence of nearby objects without any physical contact. Sensor component 814 may also include a light sensor, such as a CMOS or CCD image sensor, for use in imaging applications. In some embodiments, sensor component 814 may further include an acceleration sensor, a gyroscope sensor, a magnetic sensor, a pressure sensor, or a temperature sensor.

Communication component 816 is configured to facilitate wired or wireless communication between electronic apparatus 800 and other apparatus. Electronic apparatus 800 can access a wireless network based on a communication standard, such as Wi-Fi, 2G, 3G, 4G/LTE, 5G, or a combination thereof. In an exemplary embodiment, communication component 816 receives a broadcast signal or broadcast associated information from an external broadcast management system via a broadcast channel. In an exemplary embodiment, communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In an exemplary embodiment, electronic apparatus 800 may be implemented with one or more application specific integrated circuits (ASICs), digital signal processors (DSPs), digital signal processing devices (DSPDs), programmable logic devices (PLDs), field programming gate arrays (FPGAs), controllers, microcontrollers, microprocessors, or other electronic components, for performing the above-described methods.

In an exemplary embodiment, there is also provided a non-volatile computer readable storage medium including instructions, such as those included in memory 804, executable by processor 820 of electronic apparatus 800, for completing the above-described methods.

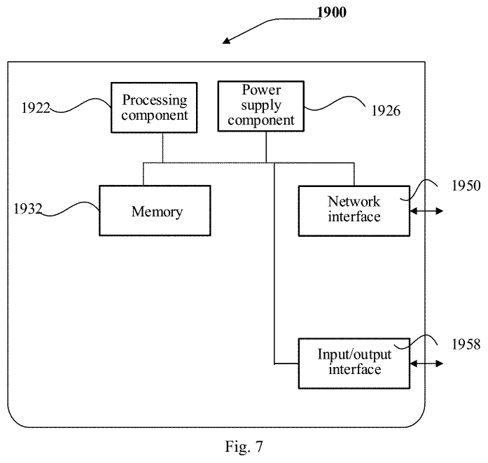

FIG. 7 shows a block diagram of an electronic apparatus 1900 provided by an embodiment of the present disclosure. For example, the electronic device 1900 may be provided as a server. Referring to FIG. 7, the electronic apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the above-described methods.

The electronic apparatus 1900 may further include a power component 1926 configured to execute power management of the electronic apparatus 1900, a wired or wireless network interface 1950 configured to connect the electronic apparatus 1900 to a network, and an Input/Output (I/O) interface 1958. The electronic apparatus 1900 may be operated on the basis of an operating systems stored in the memory 1932, such as Windows Server®, Mac OS X®, Unix®, Linux®, or FreeBSD®.

In an exemplary embodiment, there is also provided a non-volatile computer readable storage medium, for example, memory 1932 including computer program instructions, which are executable by processing component 1922 of the electronic apparatus 1900, to implement the above-mentioned methods.

The present disclosure may be a system, a method, and/or a computer program product. The computer program product may include a computer readable storage medium having computer readable program instructions thereon for causing a processor to implement various aspects of the present disclosure.

The computer readable storage medium may be a tangible apparatus that can retain and store instructions used by an instruction executing apparatus. The computer readable storage medium may be, for example, but is not limited to, an electrical storage apparatus, a magnetic storage apparatus, an optical storage apparatus, an electromagnetic storage apparatus, a semiconductor storage apparatus, or any appropriate combination of the foregoing. a non-exhaustive list of more specific examples of the computer readable storage media includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded apparatus such as punch-cards or raised structures in a groove having instructions recorded thereon, and any suitable combination of the foregoing. A computer readable storage medium, as used herein, is not to be interpreted as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing apparatuses from a computer readable storage medium or to an external computer or external storage device via a network, for example, the Internet, a local area network, a wide area network and/or a wireless network. The network may comprise copper transmission cables, optical fiber transmission, wireless transmission, routers, firewalls, switches, gateway computers and/or edge servers. The network adapter card or network interface in each computing/processing apparatus receives computer readable program instructions from the network and forwards the computer readable program instructions for storage in a computer readable storage medium within the respective computing/processing apparatus.

Computer program instructions for executing the operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including object oriented programming languages such as Smalltalk, C++ or the like, and conventional procedural programming languages such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowcharts and/or block diagrams of methods, apparatuses (systems), and computer program products according to embodiments of the present disclosure. It should be understood that each block of the flowcharts and/or block diagrams, and combinations of blocks in the flowcharts and/or block diagrams, can be implemented by computer readable program instructions.

These computer readable program instructions may be provided to a processor of a general-purpose computer, special-purpose computer, or other programmable data processing devices to produce a machine, such that the instructions, which execute via the processor of the computer or other programmable data processing devices, create means for implementing the functions/acts specified in the flowchart and/or block diagram block or blocks. These computer readable program instructions may also be stored in a computer readable storage medium that can direct a, computer, a programmable data processing device, and/or other apparatuses to function in a specific manner, such that the computer readable medium having instructions stored therein comprises an article of manufacture containing instructions for implementing aspects of the function/act specified in the flowchart and/or block diagram block or blocks.

The computer readable program instructions may also be loaded onto a computer, other programmable data processing devices or other apparatuses to cause a series of operational steps to be performed on the computer, other programmable data processing devices or other apparatuses to produce a computer implemented process, so that the instructions which execute on the computer, other programmable data processing devices or other apparatuses implement the functions/acts specified in the flowchart and/or block diagram block or blocks.

The flowcharts and block diagrams in the drawings illustrate the architecture, functionality, and operation of possible implementations of systems, methods and computer program products according to various embodiments of the present disclosure. In this aspect, each block in the flowcharts or block diagrams may represent a module, program segment, or portion of instruction, which comprises one or more executable instructions for implementing the specified logical functions. In some alternative implementations, the functions noted in the block may occur out of the order noted in the drawings. For instance, two blocks shown in succession may, in fact, be executed substantially concurrently, and the blocks may sometimes be executed in the reverse order, depending on the functionality involved. It should also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The computer program product may specifically be implemented by hardware, software, or a combination thereof. In an optional embodiment, the computer program product is specifically embodied as a computer storage medium. In another optional embodiment, the computer program product is specifically embodied as a software product, e.g., a Software Development Kit (SDK) and so forth.

Although the embodiments of the present disclosure have been described above, the above descriptions are exemplary but not exhaustive, and the disclosed embodiments are not limiting. For a person skilled in the art, a number of modifications and variations are obvious without departing from the scope and spirit of the described embodiments. The terms used herein are intended to provide the best explanations on the principles of the embodiments, practical applications, or technical improvements to the technologies in the market, or to make the embodiments described herein understandable to other persons skilled in the art.

What is claimed is:

1. A method of detecting a pedestrian event, comprising:
acquiring coordinates of a target pedestrian in multi-frame to-be-processed images;
acquiring coordinates of a preset space; and
determining a pedestrian event occurring to the target pedestrian in the preset space according to the coordinates of the target pedestrian in the multi-frame to-be-processed images and the coordinates of the preset space.

2. The method according to claim 1, wherein acquiring coordinates of a target pedestrian in the multi-frame to-be-processed images comprises:
acquiring coordinates of the target pedestrian in the multi-frame to-be-processed images by means of a deep neural network.

3. The method according to claim 2, wherein the preset space includes a preset line, and the pedestrian event includes a pedestrian cross-line event; and
determining a pedestrian event occurring to the target pedestrian in the preset space according to the coordinates of the target pedestrian in the multi-frame to-be-processed images and the coordinates of the preset space comprises:
determining a first coordinate axis perpendicular to the preset line according to the coordinates of the preset line;
according to the coordinates of the target pedestrian in the multi-frame to-be-processed images, determining projected coordinates of the target pedestrian in the multi-frame to-be-processed images on the first coordinate axis; and
determining that the target pedestrian performs the pedestrian cross-line event relative to the preset line in the case where any two of the projected coordinates are on both sides of a target point respectively, wherein the target point represents an intersection of the first coordinate axis and the preset line.

4. The method according to claim 3, wherein determining that the target pedestrian performs the pedestrian cross-line event relative to the preset line in the case where any two of the projected coordinates are on both sides of a target point respectively comprises:
determining an angle between a vector of a preset direction and a direction vector of the first coordinate axis;
determining that the target pedestrian performs a pedestrian cross-line event in the preset direction relative to the preset line, in the case where the angle is smaller than 90°, first projected coordinates and second projected coordinates of the projected coordinates are on both sides of the target point respectively, a timestamp of a to-be-processed image corresponding to the first projected coordinates is earlier than that of a to-be-processed image corresponding to the second projected coordinates, and the first projected coordinates are smaller than the second projected coordinates; and/or determining that the target pedestrian performs a pedestrian cross-line event in the preset direction relative to the preset line in the case where the angle is greater than 90°, first projected coordinates and second projected coordinates of the projected coordinates are on both sides of the target point respectively, a timestamp of a to-be-processed image corresponding to the first projected coordinates is earlier than that of a to-be-processed image corresponding to the second projected coordinates, and the first projected coordinates are larger than the second projected coordinates.

5. The method according to claim 1, wherein the preset space includes a preset region, and the pedestrian event includes a pedestrian stay event;
determining a pedestrian event occurring to the target pedestrian in the preset space according to the coordinates of the target pedestrian in the multi-frame to-be-processed images and the coordinates of the preset space comprises:
determining staying time of the target pedestrian in the preset region according to the coordinates of the target pedestrian in the multi-frame to-be-processed images and the coordinates of the preset region; and
determining that the target pedestrian performs the pedestrian stay event in the preset region in the case where the staying time is greater than or equal to a time threshold.

6. The method according to claim 1, wherein the preset space includes a preset region, and the pedestrian event includes a pedestrian wandering event;
determining a pedestrian event occurring to the target pedestrian in the preset space, according to the coordinates of the target pedestrian in the multi-frame to-be-processed images and the coordinates of the preset space comprises:
determining staying time of the target pedestrian in the preset region according to the coordinates of the target pedestrian in the multi-frame to-be-processed images and the coordinates of the preset region;
determining a cumulative moving distance of the target pedestrian within the staying time; and
determining that the target pedestrian performs the pedestrian wandering event in the preset region in the case where the staying time is greater than or equal to a time threshold and the cumulative moving distance is greater than or equal to a distance threshold.

7. The method according to claim 5, wherein determining staying time of the target pedestrian in the preset region according to the coordinates of the target pedestrian in the multi-frame to-be-processed images and the coordinates of the preset region comprises:
determining a first timestamp of a to-be-processed image when the target pedestrian appears in the preset region for the first time and a second timestamp of a to-be-processed image when the target pedestrian appears in the preset region for the last time, according to the coordinates of the target pedestrian in the multi-frame to-be-processed images, the coordinates of the preset region, and the timestamps of the multi-frame to-be-processed images; and determining a time interval between the second timestamp and the first timestamp as the staying time of the target pedestrian in the preset region; or
determining a number of images in which the target pedestrian is in the preset region in the multi-frame to-be-processed images, according to the coordinates of the target pedestrian in the multi-frame to-be-processed images and the coordinates of the preset region; and determining a product of the number of images and a duration of each frame of the to-be-processed images as a cumulative duration of the target pedestrian in the preset region, and taking the cumulative duration as the staying time of the target pedestrian in the preset region; or
determining a maximum number of continuous images in which the target pedestrian is in the preset region in the multi-frame to-be-processed images, according to the coordinates of the target pedestrian in the multi-frame to-be-processed images and the coordinates of the preset region; and determining a product of the maximum number of continuous images and a duration of each frame of the to-be-processed images as a maximum duration of the target pedestrian in the preset region, and taking the maximum duration as the staying time of the target pedestrian in the preset region.

8. The method according to claim 6, wherein determining a cumulative moving distance of the target pedestrian within the staying time comprises:
determining the to-be-processed images in which the target pedestrian is in the preset region within the staying time as stay images respectively; and
obtaining the cumulative moving distance of the target pedestrian within the staying time by accumulating the distances between the coordinates of the target pedestrian in every two adjacent frames of the stay images.

9. The method according to claim 5, wherein the method further comprises:
determining, according to the coordinates of the target pedestrian in any to-be-processed image of the multi-frame to-be-processed images and the coordinates of the preset region, an area overlap value of an area where the region the target pedestrian appears in the to-be-processed image overlaps with the preset region;
determining that the target pedestrian in the to-be-processed image is in the preset region, when the area overlap value is greater than or equal to an overlap threshold.

10. The method according to claim 9, wherein the coordinates of the target pedestrian include the coordinates of a bounding box surrounding the target pedestrian; and
determining, according to the coordinates of the target pedestrian in any to-be-processed image of the multi-frame to-be-processed images and the coordinates of the preset region, an area overlap value of the region where the target pedestrian appears in the to-be-processed image and the preset region comprises:
determining a first area of an overlapping region of a region surrounded by the bounding box in the to-be-processed image with the preset region, according to the coordinates of the bounding box of the target pedestrian in any to-be-processed image of the multi-frame to-be-processed images and the coordinates of the preset region; and
determining a ratio of the first area to an area of the region surrounded by the bounding box as the area overlap value.

11. The method according to claim 1, wherein the preset space includes a preset region, and the pedestrian event includes a pedestrian invasion event; and
determining a pedestrian event occurring to the target pedestrian in the preset space according to the coordinates of the target pedestrian in the multi-frame to-be-processed images and the coordinates of the preset space comprises:
acquiring an invasion sensitivity coefficient;
determining a second area of an overlapping region of the region surrounded by the bounding box in the to-be-processed image with the preset region, according to the coordinates of the target pedestrian in any to-be-processed image of the multi-frame to-be-processed images and the coordinates of the preset region; and
determining that the target pedestrian performs the pedestrian invasion event in the preset region in the case where a ratio of the second area to the area of the region contained in the bounding box is greater than the invasion sensitivity coefficient.

12. The method according to claim 1, wherein the method further comprises:
issuing an alarm message in a case of detecting that the target pedestrian performs the pedestrian event in the preset space.

13. The method according to claim 1, wherein the method further comprises:
extracting attribute information of the target pedestrian in the case of detecting that the target pedestrian performs the pedestrian event in the preset space; and
outputting the attribute information of the target pedestrian.

14. An electronic device, comprising:
a processor;
a memory configured to store instructions executable by the processor;
wherein the processor is configured to invoke the instructions so as to:
acquire coordinates of a target pedestrian in multi-frame to-be-processed images;
acquire coordinates of a preset space; and
determine a pedestrian event occurring to the target pedestrian in the preset space according to the coordinates of the target pedestrian in the multi-frame to-be-processed images and the coordinates of the preset space.

15. The device according to claim 14, wherein the preset space includes a preset line, and the pedestrian event includes a pedestrian cross-line event; and
determining the pedestrian event occurring to the target pedestrian in the preset space further comprises:
determining a first coordinate axis perpendicular to the preset line according to the coordinates of the preset line;
determining projected coordinates of the target pedestrian in the multi-frame to-be-processed images on the first coordinate axis according to the coordinates of the target pedestrian in the multi-frame to-be-processed images; and
determining that the target pedestrian performs the pedestrian cross-line event relative to the preset line in the case where any two of the projected coordinates are on both sides of a target point respectively, wherein the target point represents an intersection of the first coordinate axis and the preset line.

16. The device according to claim 14, wherein the preset space includes a preset region, and the pedestrian event includes a pedestrian stay event; and
determining the pedestrian event occurring to the target pedestrian in the preset space comprises:
determining staying time of the target pedestrian in the preset region according to the coordinates of the target pedestrian in the multi-frame to-be-processed images and the coordinates of the preset region; and
determining that the target pedestrian performs the pedestrian stay event in the preset region in the case where the staying time is greater than or equal to a time threshold.

17. The device according to claim 14, wherein the preset space includes a preset region and the pedestrian event includes pedestrian wandering event; and
determining the pedestrian event occurring to the target pedestrian in the preset space comprises:
determining staying time of the target pedestrian in the preset region, according to the coordinates of the target pedestrian in the multi-frame to-be-processed images and the coordinates of the preset region;
determining a cumulative moving distance of the target pedestrian within the staying time; and
determining that the target pedestrian performs the pedestrian wandering event in the preset region in the case where the staying time is greater than or equal to a time threshold and the cumulative moving distance is greater than or equal to a distance threshold.

18. The device according to claim 16, wherein determining the pedestrian event occurring to the target pedestrian in the preset space comprises:
determining a first timestamp of a to-be-processed image when the target pedestrian appears in the preset region for the first time and a second timestamp of a to-be-processed image when the target pedestrian appears in the preset region for the last time according to the coordinates of the target pedestrian in the multi-frame to-be-processed images, the coordinates of the preset region, and the timestamp of the multi-frame to-be-processed images; and determining a time interval between the second timestamp and the first timestamp as a staying time of the target pedestrian in the preset region; or
determining a number of images in which the target pedestrian is in the preset region in the multi-frame to-be-processed images according to the coordinates of the target pedestrian in the multi-frame to-be-processed images and the coordinates of the preset region; and determining a product of the number of images and a duration of each frame of the to-be-processed images as a cumulative duration of the target pedestrian in the preset region, and take the cumulative duration as the staying time of the target pedestrian in the preset region; or
determining a maximum number of continuous images in which the target pedestrian is in the preset region in the multi-frame to-be-processed images according to the coordinates of the target pedestrian in the multi-frame to-be-processed images and the coordinates of the preset region; and determining a product of the maximum number of continuous images and a duration of each frame of the to-be-processed images as a maximum duration of the target pedestrian in the preset region, and take the maximum duration as the staying time of the target pedestrian in the preset region.

19. The device according to claim 17, wherein determining the cumulative moving distance of the target pedestrian within the staying time comprises:
determining the to-be-processed images in which the target pedestrian is in the preset region within the staying time as stay images respectively; and
obtaining the cumulative moving distance of the target pedestrian within the staying time by accumulating the distances between the coordinates of the target pedestrian in every two adjacent frames of the stay images.

20. A computer readable storage medium having computer program instructions stored thereon, wherein the computer program instructions, when executed by the processors, implement the method of:
acquiring coordinates of a target pedestrian in multi-frame to-be-processed images;
acquiring coordinates of a preset space; and
determining a pedestrian event occurring to the target pedestrian in the preset space according to the coordinates of the target pedestrian in the multi-frame to-be-processed images and the coordinates of the preset space.
